(19) United States
(12) Patent Application Publication
(10) Pub. No.: US 2010/0184335 A1
(43) Pub. Date: Jul. 22, 2010

(54) ELECTRONIC CARD CONNECTOR

(75) Inventors: JIAN-FEI YU, Kunshan (CN); QI-JUN ZHAO, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/688,928

(22) Filed: Jan. 18, 2010

(30) Foreign Application Priority Data
Jan. 18, 2009 (CN) 200920300271.3

(51) Int. Cl. H01R 24/00

(52) U.S. Cl. 439/630

(57) ABSTRACT

A card connector for connecting a memory card with asymmetric side edges comprises an insulative housing having a recess for receiving the memory card. The insulative housing has an inlet in the front end of the recess for inserting the memory card, and a pair of arms in two sides of the recess. The pair of arms are asymmetric and corresponding to the side edges of the memory card, so that the card connector can block card like SD card inserted into the recess.

### BACKGROUND OF THE INVENTION

1. Field of the Invention

The present invention generally relates to a card connector for connecting a memory card.

2. Description of Related Art

Memory cards are widely used in consumer electronic products in order to increase storage capacity. There are a variety of memory cards in the market, such as SD Card (Secure Digital Memory Card), XD Card (XD-picture Card), MS Card (Memory Stick Card). All these cards have symmetrical side edges viewed from the front side of the cards, electronic card connectors for receiving the card is provided with corresponding recess. As new memory cards are promoted to the market, especially a card with asymmetric side edges. Therefore, it's necessary to develop a new card connector.

### SUMMARY OF THE INVENTION

According to one aspect of the present invention, a card connector for connecting a memory card with asymmetric side edges, comprising: an insulative housing having a recess for receiving the memory card, an inlet in the front end of the recess for inserting the memory card, and a pair of arms in two sides of the recess, the pair of arms being asymmetric and corresponding to the side edges of the memory card.

According to another aspect of the present invention, a card connector for receiving a memory card, comprising: an insulative housing having a base, a pair of arms extending from two lateral side of the base, and recess formed therebetween, a pair of asymmetric steps formed on the pair of arms and facing the recess for engaging a pair of asymmetric side edges of the memory card; a plurality of contacts fixed on the base and extending into the recess for connecting the memory card; and a shell covering the recess of the insulative housing.

Other objects, advantages and novel features of the present invention will become more apparent from the following detailed description of the present embodiment when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a card connector according to a preferred embodiment of the present invention;

FIG. 2 is a partly exploded perspective view of the card connector shown in FIG. 1 and a memory card to be received in the card connector;

FIG. 3 is a perspective view of the card connector shown in FIG. 1, in which a shell is separated;

FIG. 4 is an exploded view of the card connector shown in FIG. 1; and

FIG. 5 is another exploded view of the card connector taken from different angle as shown in FIG. 4.

### DETAILED DESCRIPTION OF THE INVENTION

Reference will be made to the drawings to describe the present invention in detail, wherein depicted elements are not necessarily shown to scale and wherein like or similar elements are designated by same or similar reference numeral through the several views and same or similar terminology.

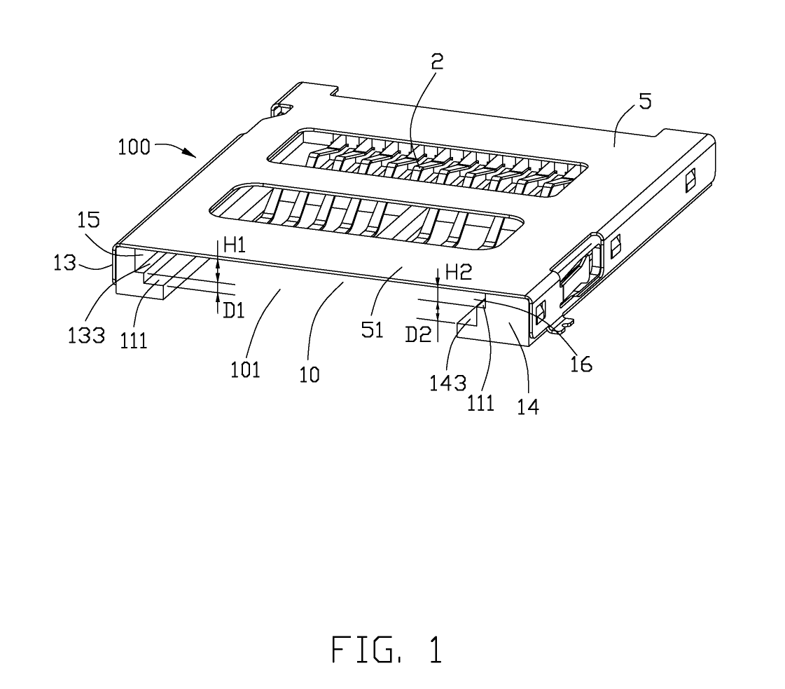

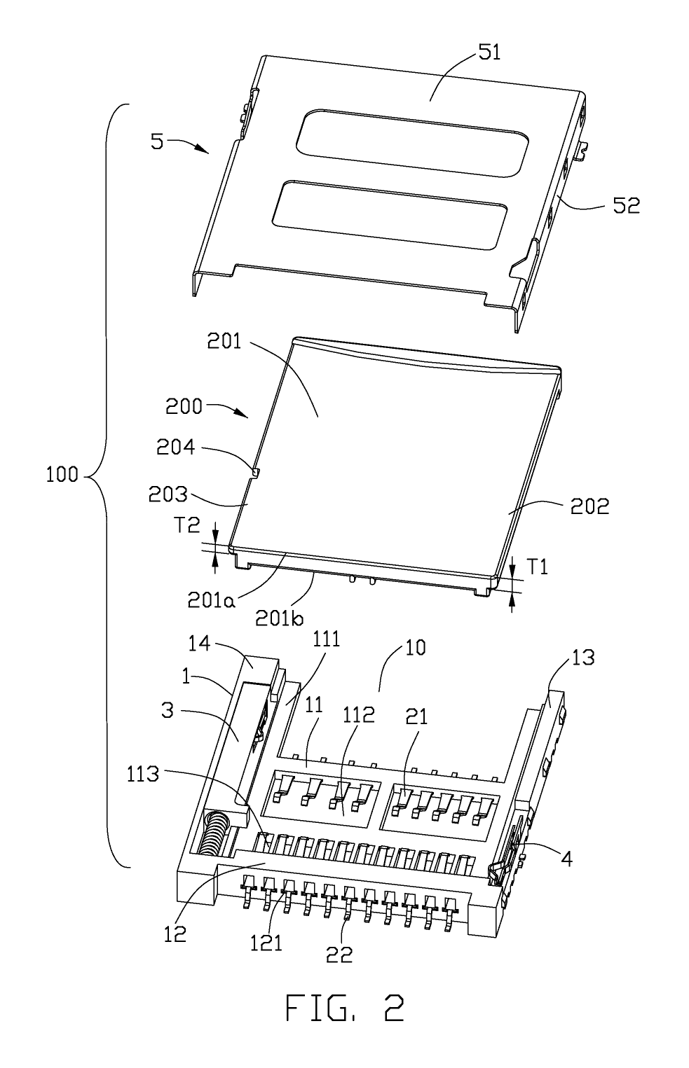

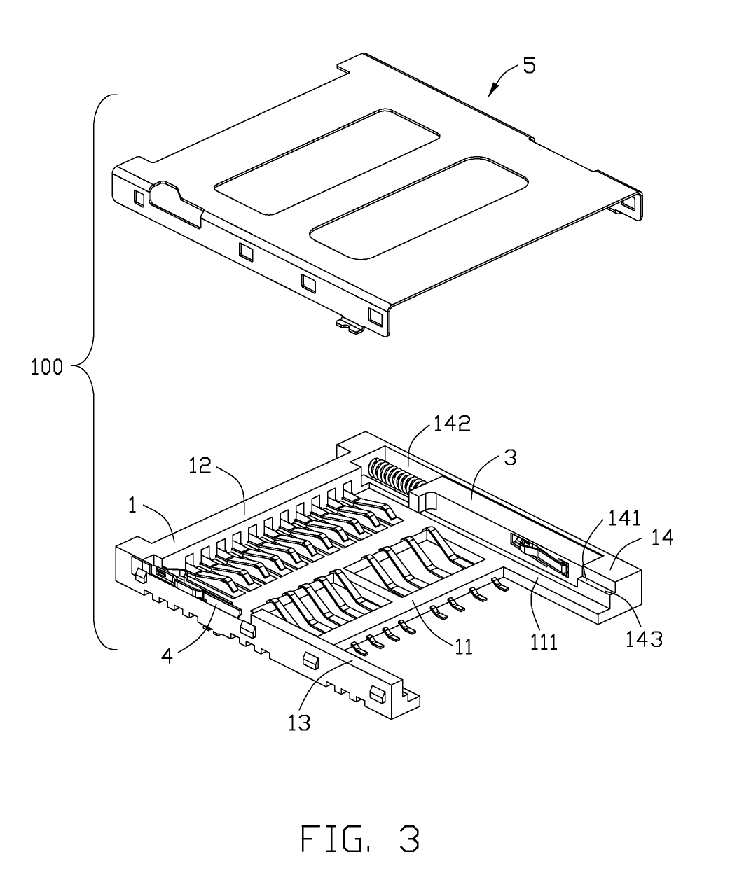

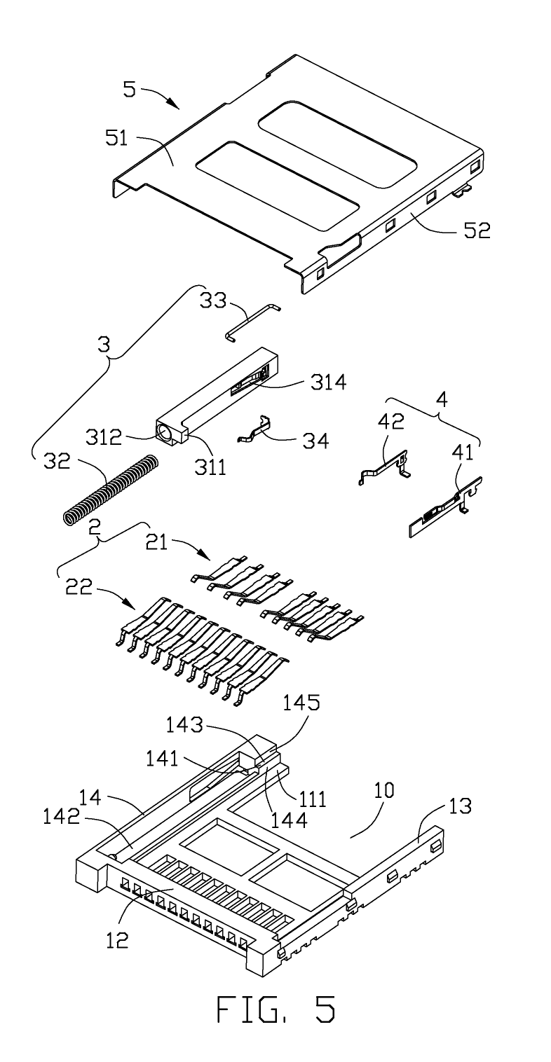

Referring to FIGS. 1-5, a card connector 100 according to the present invention is used to receive a memory card 200 shown in FIG. 2. The card connector 100 comprises an insulative housing 1, a plurality of contacts 2 fixed in the insulative housing 100, an ejecting mechanism 3 assembled at one side of the insulative housing 1, a switch 4 fixed at another side of the insulative housing 1, and a shell 5 covering the insulative housing 1.

Reference made to FIG. 2, the memory card 200 has a rectangular main body 201 with a top surface 201a and a bottom surface 201b parallel to the top surface 201a, a first side edge 202 formed at left side of the main body 201, a second side edge 203 formed at right side of the main body 201. The first and second side edges 202, 203 are recessed from the bottom surface 201b toward the upper surface 201a, and the second side edge 203 has a cutout 204 in a middle portion thereof. The first side edge 202 has a first thickness T1, and the second side edge 203 has a second thickness T2 smaller than the first thickness T1. The memory card 200 is different with a standard SD card, as two side edges of the SD card have a same thickness, and the thickness of the two side edges of the SD card is larger than the second thickness T2 of the memory card 200.

Referring to FIG. 1-5, the insulative housing 1 includes a recess 10 for receiving the memory card 200. The recess 10 has an inlet 101 at a front side of the housing 1. The memory card 200 can be inserted from the inlet 101 and received in the recess 10. The insulative housing 1 further has a base 11, a rear wall 12, a left arm 13, and a right arm 14 encircling the recess 10. The base 11 includes an inner surface 111 facing the recess 10, two opening 112 in a middle portion thereof, and a row of slots 113 near the rear wall 12. The inner surface 111 engages a bottom wall 201b of the memory card 200 and acts as a lower supporting surface 111 when the card 200 is received in the recess 10. The rear wall 12 has a plurality of holes 121 corresponding with the slots 113 respectively.

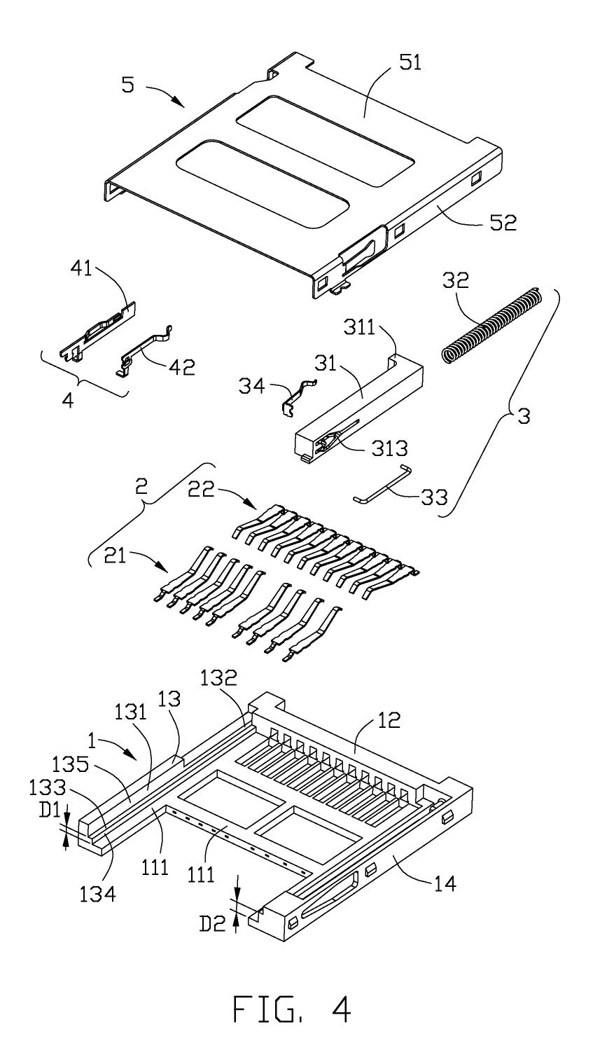

The left arm 13 has a first step 131 facing the recess 10 and a slot 132 at a rear portion for receiving the switch 4. The first step 131 is formed along the left arm 13 and has a first supporting surface 133, a first engaging surface 134 and a second engaging surface 135. The first supporting surface 133 is parallel with the lower supporting surface 111. The first engaging surface 134 connects the lower and the first supporting surface 111, 133 perpendicularly. The second engaging surface 135 is perpendicular to the first supporting surface 133. There is a first distance D1 between the lower and the first supporting surface 111, 133 shown in FIG. 4 and FIG. 1, the first distance D1 is also the height of the first engaging surface 134.

The right arm 14 has a second step 141 facing the recess 10 and a groove 142 in the middle portion for seating the ejecting mechanism 3. Similar to the first step 131, the second step 141 has a second supporting surface 143, a third engaging surface 144 and a forth engaging surface 145. The second supporting surface 143 is parallel with the lower supporting surface 111. The third engaging surface 144 connects the lower and the second supporting surface 111, 143 perpendicularly. The forth engaging surface 145 is perpendicular to the second supporting surface 143. There is a second distance D2 between the lower and second supporting surface 111, 143 shown in FIG. 1, the second distance D2 is also the height of the third engaging surface 144. The second distance D2 is larger than the first distance D1, and the first supporting surface 133 is lower than the second supporting surface 143 with reference to the lower supporting surface 111.

Reference further made to FIG. 1-5, the shell 5 has a top wall 51 and two side walls 52 perpendicularly extending form two sides of the top wall 51. The top wall 51 covers the recess 10, and the side walls embrace the arms 13, 14 respectively. As shown in FIG. 1, a first guiding slot 15 is formed between the first supporting surface 133 and the top wall 51, and the first guiding slot 15 has a first Height H1, The first Height H1 is equal to or a little larger than the thickness T1 of the first edge 202 of the memory card 200. A second guiding slot 16 is formed between the second supporting surface 143 and the top wall 51, the second guiding slot 16 has s second Height H2, the second Height H2 is equal to or a little larger than the thickness T2 of the second side edge 203 of the memory card 200. Therefore, the memory card 20 can be inserted to the connector 100, and the second height H2 is smaller than the thickness of a side edge of a SD card.

Referring to FIGS. 2-5, two rows of contacts 2 are fixed on the insulative housing 1 respectively. A first row of contacts 21 are insert-molded in the base 11, and a portion of the contacts 21 extends above the opening 112. A second row of contacts 22 are inserted into the holes 121 on the rear wall 12 and extend above the slots 113 of the rear wall 12.

Referring to FIGS. 2-5, the ejecting mechanism 3 is mounted in the groove 142 of the right arm 14 and can move in a card insertion or ejection direction. The ejecting mechanism 3 includes a slider 31, a coil spring 32, a lever 33 and a holding plate 34. The slider 31 has a protrusion 311 for abutting against a front end of the memory card 200, a blind hole 312, a cam groove 313 formed on an outside surface thereof, a slot 314 formed on an inner surface thereof. The protrusion 311 extends into the recess 10 for engaging the front end of the memory card 200. The blind hole 312 receives one end of the coil spring 32, the other end of the coil spring 32 leans against the rear wall 12. The coil spring 32 provides biasing force for the slider 31 when the memory card 200 is inserted or pulled out of the connector 1. One end of the lever 33 is rotatably mounted in the right arm 12, and another end of the lever 33 is located and can moves in the cam groove 313. The holding plate 34 is assembled in the slot 314 and extends into the recess 10 for latching the cutout 205 of the memory card 200.

Referring to FIGS. 2-5, the switch 4 is mounted in the slot 132 of the left arm 13. The switch 4 includes a first contact 41 and a second contact 42. When the memory card 200 is inserted into the recess 10, the first contact 41 makes contact with the second contacts 42.

The memory card 200 has asymmetric side edges 202, 203, as the thickness T2 of second side edge 203 is smaller than the first thickness T1 of the first side edge 202. The card connector 100 has asymmetric arms 13, 14 corresponding to the asymmetric side edges 202, 203 of the memory card 200, the first supporting surface 133 is lower than the second supporting surface 143, and the first guiding slot 15 is wider than the second guiding slot 16. The first guiding slot 15 is a little wider than or same with the first side edge 202, and the second guiding slot 16 is a little wider or same with the second side edge 203, therefore the side edges 202, 203 moves along the guiding slots 15,16 when the memory card 200 is inserted from the inlet 101. Whereas, a SD card has symmetric side edges with a thickness larger than the second height H2, the second guiding slot 16 blocks the SD card inserting into the recess 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card connector for connecting a memory card with asymmetric side edges, comprising:
an insulative housing having a recess for receiving the memory card, an inlet in a front end of the recess for inserting the memory card, and a pair of arms in two sides of the recess, the pair of arms being asymmetric and corresponding to the side edges of the memory card.

2. The card connector as claimed in claim 1, wherein a first guiding slot of a first height is formed on a first one of said arms, and a second guiding slots of a second height is formed on a second one of said arms, the first height is larger than the second height, and the second guiding slot blocking a card having a side edge wider than the seconding guiding slot.

3. The card connector as claimed in claim 2, wherein said housing includes a base connecting said arms, the base comprises a lower supporting surface facing said recess, said first guiding slot has a first supporting surface parallel with the lower supporting surface, said second guiding slot has a second supporting surface parallel with the lower supporting surface, and the first supporting surface is lower than the second supporting surface with reference to the lower supporting surface.

4. The card connector as claimed in claim 3, wherein said first guiding slot receives a first side edge of said memory card, a first thickness of the first side edge is smaller than or same with said first height, said second guiding slot receives a second side edge of said memory card, a second thickness of the second edge is smaller than or same with said second height, and the first thickness is larger than the second thickness.

5. The card connector as claimed in claim 4, wherein said first arm includes a first engaging surface connecting said lower supporting surface and said first supporting surface perpendicularly, said second arm includes a second engaging surface connecting said lower supporting surface and said first supporting surface perpendicularly, the first engaging surface is narrower than the second engaging surface in a direction perpendicular to said lower supporting surface.

6. The card connector as claimed in claim 4, wherein further comprising a shell covering an upper side of said insulative housing, said inlet is formed between said shell, said lower supporting surface, and said arms.

7. The card connector as claimed in claim 6, wherein said first guiding slot is formed between said shell and said first guiding surface, said second guiding slot is formed between said shell and said second guiding surface.

8. The card connector as claimed in claim 2, wherein said second height of said second guiding slot is smaller than a thickness of a side edge of an SD card, said second guiding slot blocks the SD card from inserting into said recess.

9. The card connector as claimed in claim 1, wherein further comprises an ejecting mechanism assembled on one of said arms, the ejecting mechanism including a slider engaging said memory card and moving in a card inserting direction, a spring biasing the ejector, and a lever connecting to the slider and said housing respectively for limiting movement of the slider.

10. A card connector for receiving a memory card, comprising:
an insulative housing having a base, a pair of arms extending from two lateral side of the base, and recess formed therebetween, a pair of asymmetric steps formed on the pair of arms and facing the recess for engaging a pair of asymmetric side edges of the memory card;
a plurality of contacts fixed on the base and extending into the recess for connecting the memory card; and
a shell covering the recess of the insulative housing.

11. The card connector as claimed in claim 10, wherein said base defines a lower supporting surface, a first one of said steps includes a first supporting surface parallel with the lower supporting surface, a second one of said steps includes a second supporting surface parallel with and higher than the first supporting surface, and these supporting surfaces abuts bottom side of said memory card when said memory card inserted into said recess.

12. The card connector as claimed in claim 11, wherein a first guiding slot is defined between said shell and said first support surface, and a second guiding slot is defined between said shell and said second supporting surface and narrower than the first guiding slot

13. An electrical card connector comprising:
an insulative housing defining a mating face with a card receiving space confronting said mating face in a vertical direction;
a plurality of contacts disposed in the housing with contacting sections extending into the card receiving space in said vertical direction;
a card insertion opening formed in front of the housing in a front-to-back direction perpendicular to said vertical direction; and
a card restriction device formed around the card insertion opening and including opposite first and second step structures by opposite first and second lateral sides of said card insertion opening in a transverse direction perpendicular to both said vertical direction and said front-to-back direction; wherein
each of the first step structure and the second step structure is categorized with an upper section and a lower section under condition that said first step structure and said second step structure have a same full dimension with each other in the vertical direction while the upper section of the first step structure is smaller than that of the second step structure in the vertical direction while the lower section of the first step structure is larger than that of the second step structure in the vertical direction.

14. The electrical card connector as claimed in claim 13, wherein the upper section of the first step structure is essentially similar to that of the second step structure in the transverse direction.

15. The electrical card connector as claimed in claim 13, wherein lower section of the first step structure is essentially similar to that of the second step structure in the transverse direction.

16. The electrical card connector as claimed in claim 13, wherein at least one of said first step structure and said second step structure is formed unitarily with the housing.
